(19) United States
(12) Patent Application Publication
(10) Pub. No.: US 2019/0118403 A1
(43) Pub. Date: Apr. 25, 2019

(54) Powered Saw Starting System

(71) Applicants: Keith Kartman, Pittsburgh, PA (US); Julie Kartman, Pittsburgh, PA (US)

(72) Inventors: Keith Kartman, Pittsburgh, PA (US); Julie Kartman, Pittsburgh, PA (US)

(21) Appl. No.: 15/790,541

(22) Filed: Oct. 23, 2017

(51) Int. Cl. B27B 17/00; F02N 11/08

(52) U.S. Cl. CPC B27B 17/00; F02N 11/0862; F02N 11/0803

(57) ABSTRACT

A powered saw starting system for automatically starting a chainsaw includes a chainsaw that has a housing and an internal combustion engine is positioned in the housing. A starting unit is coupled to the chainsaw and the starting unit is in mechanical communication with the internal combustion engine. The starting unit rotates the internal combustion engine when the starting unit is turned on. In this way the internal combustion engine may be started without manipulating a pull start. Thus, the starting unit inhibits a user from manually starting the internal combustion engine.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including information disclosed under 37 CFR 1.97 and 1.98.

The disclosure and prior art relates to starting devices and more particularly pertains to a new starting device for automatically starting a chainsaw.

### BRIEF SUMMARY OF THE INVENTION

An embodiment of the disclosure meets the needs presented above by generally comprising a chainsaw that has a housing and an internal combustion engine is positioned in the housing. A starting unit is coupled to the chainsaw and the starting unit is in mechanical communication with the internal combustion engine. The starting unit rotates the internal combustion engine when the starting unit is turned on. In this way the internal combustion engine may be started without manipulating a pull start. Thus, the starting unit inhibits a user from manually starting the internal combustion engine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a powered saw starting system according to an embodiment of the disclosure.

FIG. 2 is a left side view of an embodiment of the disclosure.

FIG. 3 is a right side view of an embodiment of the disclosure.

FIG. 4 is a top view of an embodiment of the disclosure.

FIG. 5 is a back phantom view of an embodiment of the disclosure.

FIG. 6 is a schematic view of an embodiment of the disclosure.

### DETAILED DESCRIPTION OF THE INVENTION

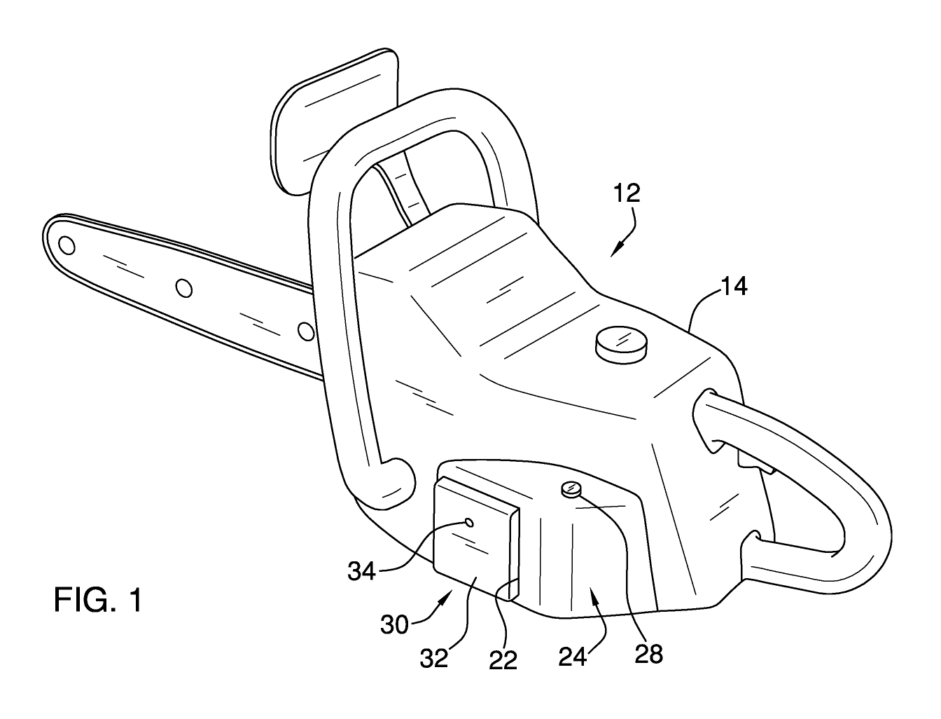

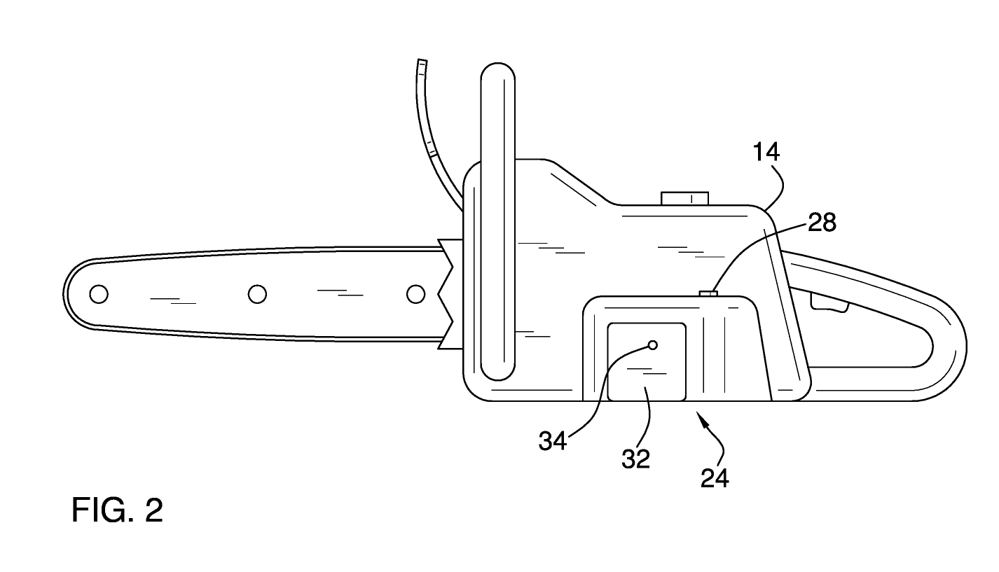

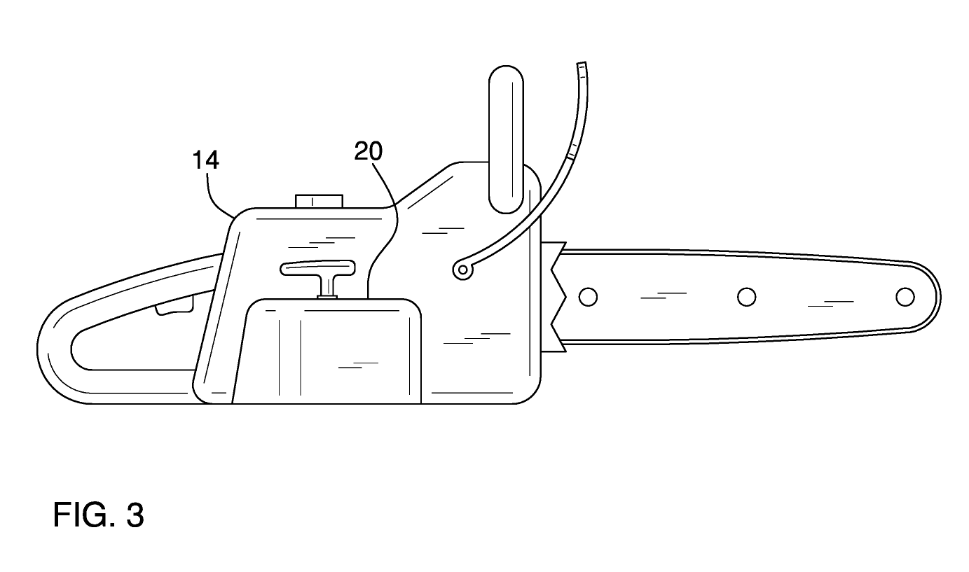

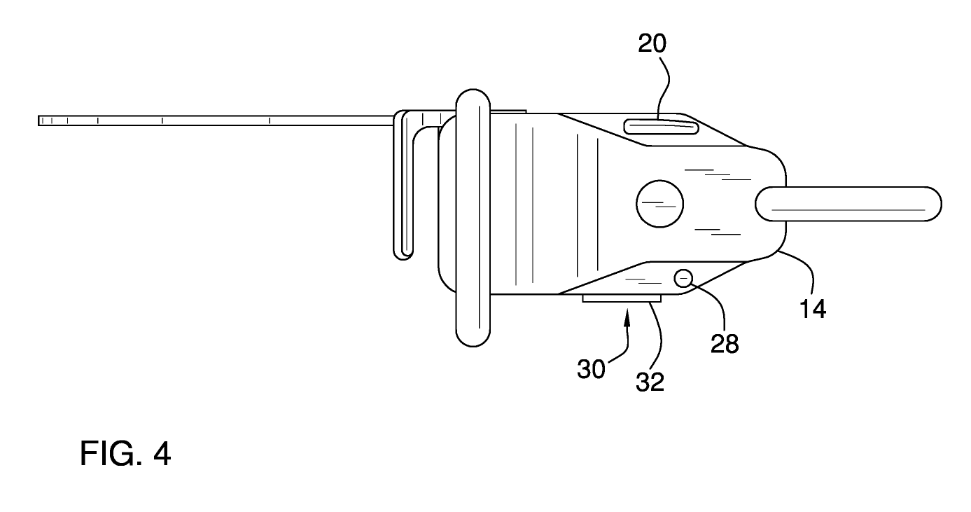

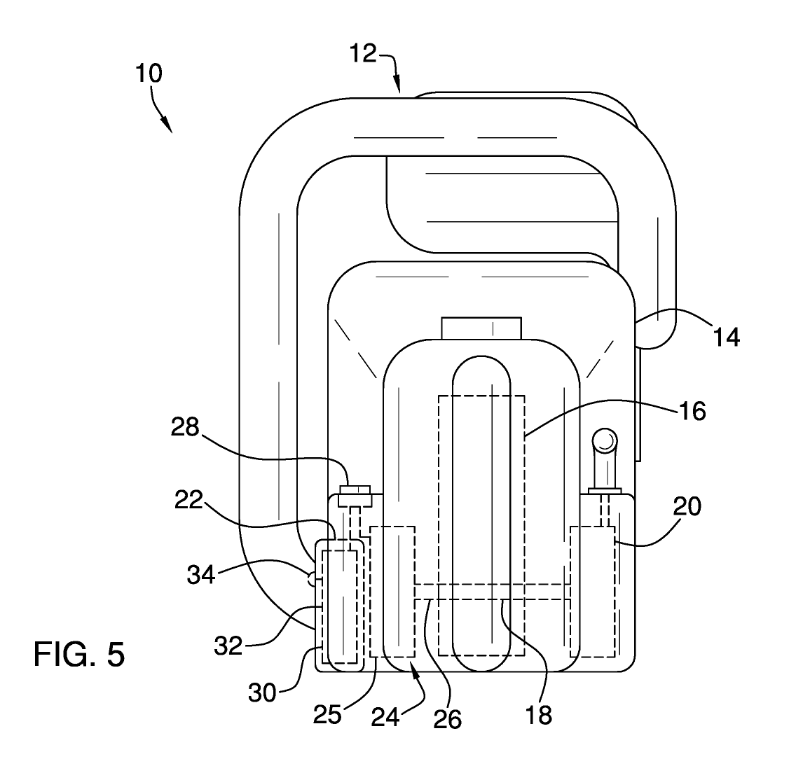

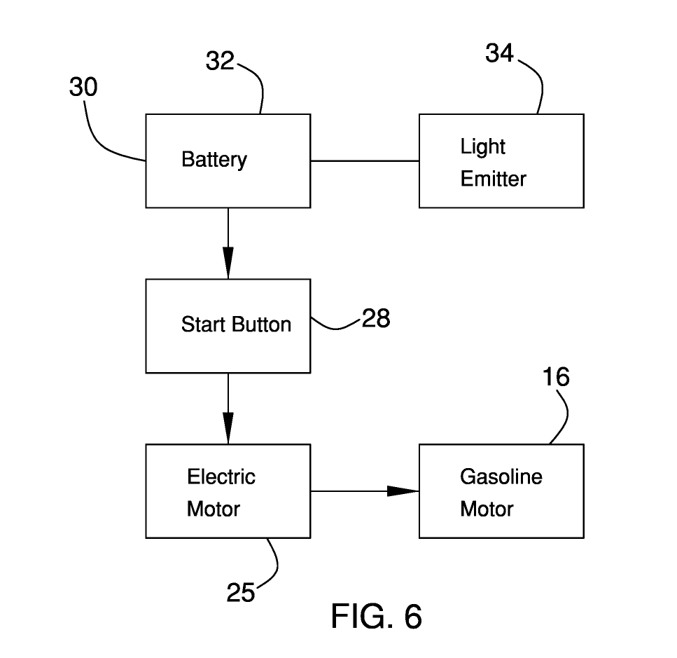

With reference now to the drawings, and in particular to FIGS. 1 through 6 thereof, a new starting device embodying the principles and concepts of an embodiment of the disclosure and generally designated by the reference numeral 10 will be described.

As best illustrated in FIGS. 1 through 6, the powered saw starting system 10 generally comprises a chainsaw 12 that has a housing 14 and an internal combustion engine 16 that is positioned in the housing 14. The internal combustion engine 16 has a crankshaft 18 and the chainsaw 12 has a pull start 20. The pull start 20 is coupled to the crankshaft 18 for manually starting the internal combustion engine 16. The internal combustion engine 16 may be a two stoke engine that has a displacement greater than 50.0 cubic centimeters. The housing 14 may have a battery well 22 extending inwardly therein and the battery well 22 may be positioned on an opposite side of the housing 14 with respect to the pull start 20.

A starting unit 24 is provided and the starting unit 24 is coupled to the chainsaw 12. The starting unit 24 is in mechanical communication with the internal combustion engine 16. Thus, the starting unit 24 rotates the internal combustion engine 16 when the starting unit 24 is turned on. In this way the internal combustion engine 16 may be started without manipulating the pull start 20 to inhibit a user from manually starting the internal combustion engine 16. Alternatively, the starting unit 24 may be positioned on a concrete saw, a cut off saw and any other saw that is powered with an internal combustion engine 16.

The starting unit 24 comprises an electric motor 25 that is positioned in the housing 14. A shaft 26 is coupled between the electric motor 25 and the crankshaft 18 on the internal combustion engine 16. The shaft 26 spins the crankshaft 18 when the electric motor 25 is turned on for starting the internal combustion engine 16. A button 28 is coupled to the housing 14 and the button 28 is selectively manipulated to turn the starting unit 24 on. The button 28 is electrically coupled to the electric motor 25 and the button 28 turns the electric motor 25 on when the button 28 is depressed.

A power supply 30 is positioned in the housing 14 and the power supply 30 is electrically coupled to the button 28. The power supply 30 comprises at least one rechargeable battery 32 is removably positioned in the housing 14. The at least one rechargeable battery 32 may be removably inserted into the battery well 22 in the housing 14. The electric motor 25 may have battery terminals that electrically engage the at least one rechargeable battery 32 when the at least one rechargeable battery 32 is inserted into the battery well 22. The at least one rechargeable battery 32 may be selectively charged on an electronic charger or the like.

A light emitter 34 is coupled to the housing 14 to selectively emit light outwardly therefrom. The light emitter 34 is electrically coupled to the at least one rechargeable battery 32. Moreover, the light emitter 34 emits an intensity of light that corresponds to a charge level of the at least one rechargeable battery 32. The light emitter 34 may be an LED or the like.

In use, the button 28 is depressed to start the internal combustion engine 16 in the chainsaw 12. The electric motor 25 spins the crankshaft 18 on the internal combustion engine 16 until the internal combustion engine 16 starts. The button 28 is released when the internal combustion engine 16 is running. In this way the electric motor 25 reduces fatigue associated with manually starting the internal combustion engine 16. Additionally, the at least one rechargeable battery 32 is selectively removed from the housing 14 for recharging. The internal combustion engine 16 may be selectively started with the pull start 20 in lieu of the electric motor 25.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A powered saw starting system for automatically starting an internal combustion engine on a saw, said system comprising:
a chainsaw having a housing and an internal combustion engine being positioned in said housing, said internal combustion engine having a crankshaft, said housing of chainsaw having a rear face and a pair of lateral faces extending forwardly from respective opposite sides of said rear face, said housing having a pair of lateral extensions extending outwardly from respective ones of said lateral faces, each of said lateral extensions having respective upper and lower surfaces, said upper and lower surfaces of each of said pair of lateral extensions being parallel to each other; and
a starting unit being coupled to said chainsaw, said starting unit being in mechanical communication with said internal combustion engine, said starting unit rotating said internal combustion engine when said starting unit is turned on thereby facilitating said internal combustion engine to be started without manipulating a pull start wherein said starting unit is configured to inhibit a user from manually starting said internal combustion engine, said starting unit comprising
an electric motor being positioned in said housing, and
a button being coupled to said housing wherein said button is configured to be manipulated, said button being electrically coupled to said electric motor such that said button turns said electric motor on when said button is depressed, said button being positioned on said upper surface of one of said pair of lateral extensions wherein said button is configured to be pressable while exerting pressure on said lower surface of said one of said pair of lateral extensions.

2. (canceled)

3. The assembly according to claim 1, further comprising a shaft being coupled between said electric motor and said crankshaft on said internal combustion engine such that said shaft spins said crankshaft when said electric motor is turned on for starting said internal combustion engine.

4. (canceled)

5. The assembly according to claim 1, further comprising a power supply being positioned in said housing, said power supply being electrically coupled to said button.

6. The assembly according to claim 5, wherein said power supply comprises at least one rechargeable battery being removably positioned in said housing.

7. The assembly according to claim 6, further comprising a light emitter being coupled to said housing wherein said light emitter is configured to selectively emit light outwardly therefrom, said light emitter being electrically coupled to said at least one rechargeable battery such that said light emitter indicates a charge level of said at least one rechargeable battery.

8. A powered saw starting system for automatically starting an internal combustion engine on a saw, said system comprising:
a chainsaw having a housing and an internal combustion engine being positioned in said housing, said internal combustion engine having a crankshaft, said housing of chainsaw having a rear face and a pair of lateral faces extending forwardly from respective opposite sides of said rear face, said housing having a pair of lateral extensions extending outwardly from respective ones of said lateral faces, each of said lateral extensions having respective upper and lower surfaces, said upper and lower surfaces of each of said pair of lateral extensions being parallel to each other; and
a starting unit being coupled to said chainsaw, said starting unit being in mechanical communication with said internal combustion engine, said starting unit rotating said internal combustion engine when said starting unit is turned on thereby facilitating said internal combustion engine to be started without manipulating a pull start wherein said starting unit is configured to inhibit a user from manually starting said internal combustion engine, said starting unit comprising:
an electric motor being positioned in said housing,
a shaft being coupled between said electric motor and said crankshaft on said internal combustion engine such that said shaft spins said crankshaft when said electric motor is turned on for starting said internal combustion engine,
a button being coupled to said housing wherein said button is configured to be manipulated, said button being electrically coupled to said electric motor such that said button turns said electric motor on when said button is depressed, said button being positioned on said upper surface of one of said pair of lateral extensions wherein said button is configured to be pressable while exerting pressure on said lower surface of said one of said pair of lateral extensions, and
a power supply being positioned in said housing, said power supply being electrically coupled to said button, said power supply comprising:
at least one rechargeable battery being removably positioned in said housing; and
a light emitter being coupled to said housing wherein said light emitter is configured to selectively emit light outwardly therefrom, said light emitter being electrically coupled to said at least one rechargeable battery such that said light emitter indicates a charge level of said at least one rechargeable battery.
